(19) United States
(12) Patent Application Publication
(10) Pub. No.: US 2015/0055003 A1
(43) Pub. Date: Feb. 26, 2015

(54) PORTABLE ELECTRONIC DEVICE

(71) Applicant: CHIUN MAI COMMUNICATION SYSTEMS, INC., New Taipei (TW)

(72) Inventors: WEI-RUNG CHEN, New Taipei (TW); KAI-LUN YU, New Taipei (TW)

(73) Assignee: CHIUN MAI COMMUNICATION SYSTEMS, INC., New Taipei (TW)

(21) Appl. No.: 14/140,714

(22) Filed: Dec. 26, 2013

(30) Foreign Application Priority Data
Aug. 22, 2013 (CN) 2013205145440

(51) Int. Cl. H04N 5/232; H04N 5/225

(52) U.S. Cl. CPC H04N 5/23293; H04N 5/2251
USPC 348/333.01

(57) ABSTRACT

A portable electronic device includes a main body, a camera, a primary display unit, a secondary display unit, and a screen control unit. The main body includes a first surface and a second surface opposite to the first surface. The camera is positioned in the main body. The primary display unit is positioned on the first surface. The secondary display unit is positioned on the second surface. The screen control unit is electronically connected to the camera, the primary display unit, and the secondary display unit. The screen control unit receives an image captured by the camera, processes the received image and sends the processed image to the primary display unit or the secondary display unit.

### BACKGROUND

1. Technical Field

The disclosure generally relates to portable electronic devices, and particularly to a portable electronic device with two display units.

2. Description of the Related Art

Portable electronic devices, such as mobile phones are usually equipped with a camera for taking photographs. The portable electronic device includes a main body, a camera, and a screen. The main body includes a first surface and a second surface opposite to the first surface. The main body further defines a through hole in the second surface. The screen is positioned on the first surface. The camera is positioned in the main body and receives light via the through hole, such that an image captured by the camera can be seen via the screen.

However, when the phone is used to take a self-portrait by aiming the camera at oneself, because the display unit is opposite to the camera, it is inconvenient to focus a clear self-portrait.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

FIG. 1 is a schematic view of a portable electronic device, according to an exemplary embodiment.

FIG. 2 is similar to FIG. 1, but viewed from another angle.

FIG. 3 is a block diagram of the portable electronic device shown in FIG. 1.

### DETAILED DESCRIPTION

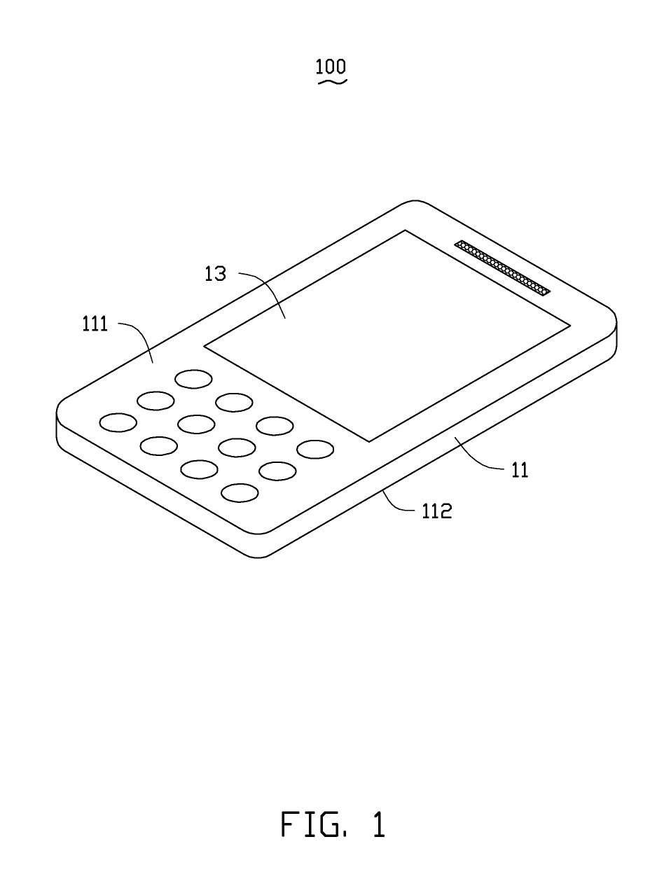

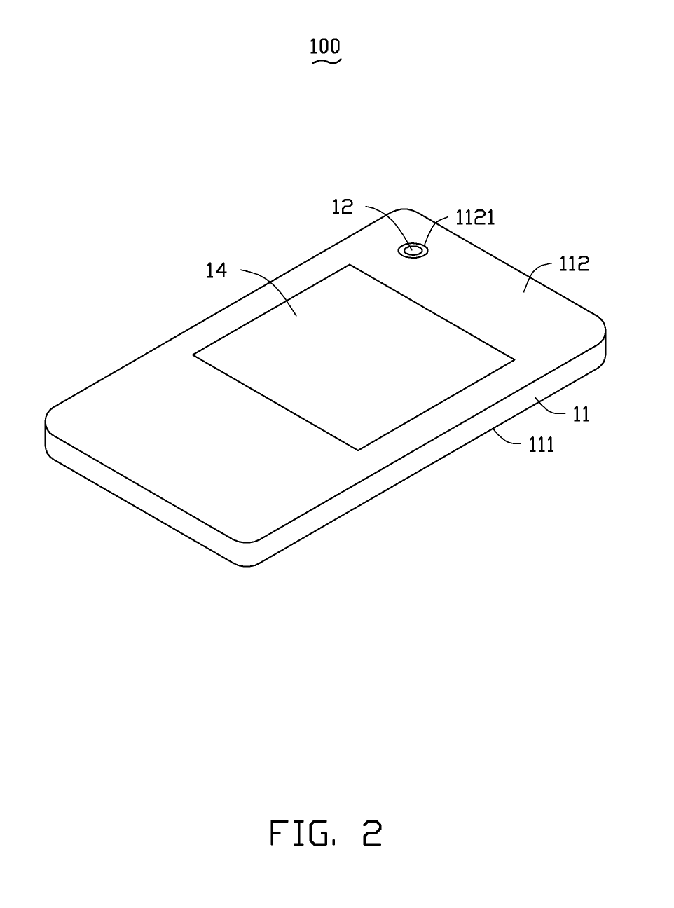

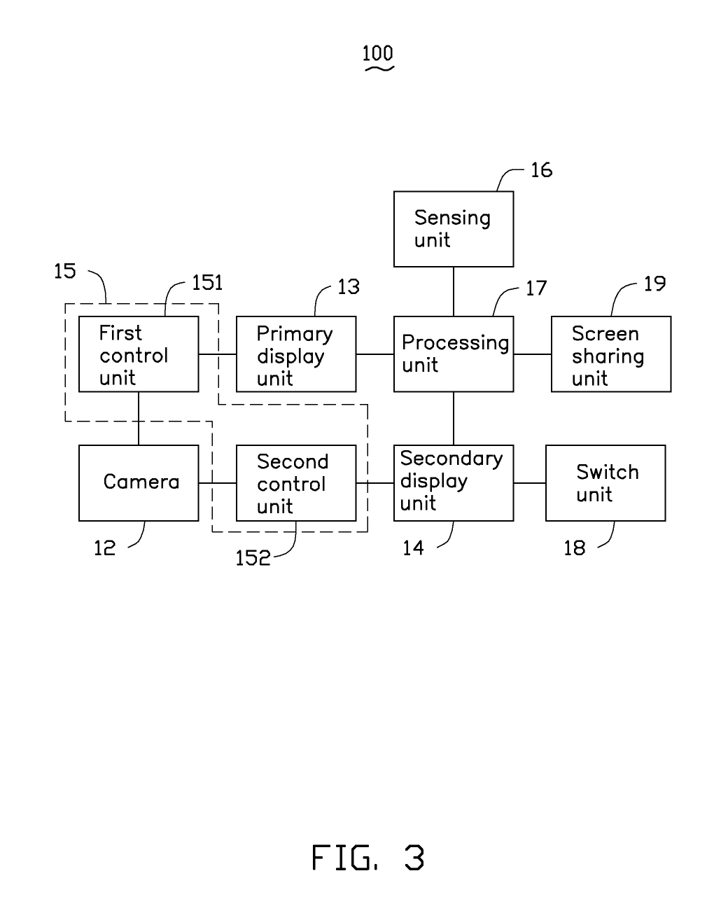

FIGS. 1 and 2 show a portable electronic device 100, according to an exemplary embodiment. The portable electronic device 100 may be a mobile phone, a notebook computer, or other electronic devices having a camera function. In this embodiment, the portable electronic device 100 is a mobile phone. FIG. 3 shows that the portable electronic device 100 includes a main body 11, a camera 12, a primary display unit 13, a secondary display unit 14, a screen control unit 15, a sensing unit 16, a processing unit 17, a switch unit 18, and a screen sharing unit 19. The camera 12, the primary display unit 13, and the secondary display unit 14 are all electronically connected to the screen control unit 15. The primary display unit 13, the secondary display unit 14, the sensing unit 16, and the screen sharing unit 19 are all electronically connected to the processing unit 17.

The main body 11 includes a first surface 111 and a second surface 112 opposite to the first surface 111. The main body 11 defines a through hole 1121 in the second surface 112. The camera 12 is positioned in the main body 11 and faces the through hole 1121, such that the camera 12 can receive light via the through hole 1121 and capture images.

The primary display unit 13 is positioned on the first surface 111 of the main body 11. The secondary display unit 14 is positioned on the second surface 112 adjacent to the camera 12 and opposite to the primary display unit 13. The primary display unit 13 and the secondary display unit 14 are both configured to display function interfaces of the portable electronic device 100, such as signal strength, battery remaining capacity, current date and time, incoming call, or image information.

The screen control unit 15 is electronically connected to the camera 12, the primary display unit 13, and the secondary display unit 14. The screen control unit 15 receives images captured by the camera 12, processes the received images (e.g., adjusting pixels, improving definition rate, or modifying color), and sends the processed images to the primary display unit 13 or the secondary display unit 14.

In detail, the screen control unit 15 includes a first control unit 151 and a second control unit 152. The first control unit 151 is electronically connected to the camera 12 and the primary display unit 13. The first control unit 151 receives images captured by the camera 12, processes the received images (e.g., adjusting pixels, improving definition rate, or modifying color), and sends the processed images to the primary display unit 13. The second control unit 152 is similar to the first control unit 151, but sends the processed images to the secondary display unit 14.

The sensing unit 16 may be a gravity sensor. The sensing unit 16 is positioned in an interior of the main body 11 and is electronically connected to the processing unit 17. The sensing unit 16 senses a relative position relation of the two display units (i.e., the primary display unit 13 and the secondary display unit 14) and outputs a sensing signal to the processing unit 17. The sensing signal indicates which display unit is positioned above the other display unit.

The processing unit 17 may be a MSM8260, MSM8660, or MSM8930 chip. The processing unit 17 is configured for controlling one of the primary display unit 13 and the secondary display unit 14 to be in an activated state, and the other to be in an inactivated state according to whether the sensing signal was received from the sensing unit 16 or not. For example, when the processing unit 17 receives a first sensing signal which indicates that the primary display unit 13 is positioned above the secondary display unit 14, the processing unit 17 controls the primary display unit 13 to enter the activated state and the secondary display 14 remains in the inactivated state. In this way, corresponding function interfaces, such as signal strength, battery remaining capacity, current date and time, incoming call, or image information, are sent to and displayed on the primary display unit 13.

When the processing unit 17 receives a second sensing signal which indicates that the secondary display unit 14 is positioned above the primary display unit 13, the processing unit 17 controls the secondary display unit 14 to enter the activated state and the primary display unit 13 remains in the inactivated state. In this way, corresponding function interfaces, such as signal strength, battery remaining capacity, current date and time, incoming call, or image information, are sent to and displayed on the secondary display unit 14.

Furthermore, if the processing unit 17 does not receive any signal from the sensing unit 16, which indicates the portable electronic device 100 is held and operated by a user in a longitudinal direction. The processing unit 17 also controls the primary display unit 13 to enter the activated state and the secondary display unit 14 remains in the inactivated state. In this way, corresponding function interfaces, such as signal strength, battery remaining capacity, current date and time, incoming call, or image information, are sent to and displayed on the primary display unit 13.

The switch unit 18 and the screen sharing unit 19 can be integrated with number keys or function buttons (e.g., a volume adjusting button or a power button) of the portable electronic device 100. The switch unit 18 is electronically connected to the secondary display unit 14. When the portable electronic device 100 is used for self-portrait, the user can turn on/off the secondary display unit 14 via the switch unit 18.

When one of the primary display unit 13 and the secondary display unit 14 is in the activated state, and the screen sharing unit 19 is pressed, a triggering signal is generated and sent to the processing unit 17. The processing unit 17 receives the triggering signal and activates the inactivated display unit to synchronously display contents along with the activated display unit in response to the triggering signal, so that the user and others can share the portable electronic device 100. For example, when the primary display unit 13 is in the activated state and the processing unit 17 receives the triggering signal from the screen sharing unit 19, the processing unit 17 also controls the secondary display unit 14 to enter the activated state. In this way, the function interfaces displayed on the primary display unit 13 is also sent to and displayed on the secondary display unit 14.

In other embodiments, the secondary display unit 14 may be an organic light-emitting diode to decrease a thickness of the portable electronic device 100.

When the portable electronic device 100 is used for capturing images, the camera 12 faces and aims at an object, and a captured image can be seen via the primary display unit 13, such that the user can adjust a position of the portable electronic device 100 to capture a clear image. When the portable electronic device 100 is used for taking self-portrait, the camera 12 is facing the user, and images captured can be seen via the secondary display unit 14, such that the user can adjust a position of the portable electronic device 100 to capture a clear image.

In summary, due to the secondary display unit 14 positioned on the second surface 112 and adjacent to the camera 12, when the portable electronic device 100 is used for taking self-portrait, the camera 12 faces the user, and an image captured can be seen via the secondary display unit 14, such that the user can adjust a position of the portable electronic device 100 to capture a clear image. Furthermore, the processing unit 17 can switch on one of the primary display unit 13 and the secondary display unit 14 and switches off the other display unit according to a detected relative position relation between the two display units, thereby saving battery life.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in matters of arrangement of parts within the principles of this disclosure to the full extent indicated by the broad general meaning of the terms in which the appended claims are expressed.

What is claimed is:

1. A portable electronic device, comprising:
a main body comprising a first surface and a second surface opposite to the first surface;
a camera positioned in the main body;
a primary display unit positioned on the first surface;
a secondary display unit positioned on the second surface; and
a screen control unit electronically connected to the camera, the primary display unit, and the secondary display unit; wherein the screen control unit receives an image captured by the camera, processes the received image and sends the processed image to the primary display unit or the secondary display unit.

2. The portable electronic device of claim 1, wherein the screen control unit comprises a first control unit, the first control unit is electronically connected to the camera and the primary display unit, the first control unit receives the image captured by the camera, processes the received image, and sends the processed image to the primary display unit.

3. The portable electronic device of claim 2, wherein the screen control unit further comprises a second control unit, the second control unit is electronically connected to the camera and the secondary display unit, the second control unit receives the image captured by the camera, processes the received image, and sends the processed image to the secondary display unit.

4. The portable electronic device of claim 1, further comprising a switch unit, wherein the switch unit is electronically connected to the secondary display unit, the switch unit turns on/off the secondary display unit.

5. The portable electronic device of claim 1, wherein the second surface defines a through hole; the camera faces the through hole, receives light via the through hole and captures the image.

6. The portable electronic device of claim 1, wherein the secondary display unit is an organic light-emitting diode.

7. The portable electronic device of claim 1, further comprising a processing unit, wherein the processing unit is electronically connected to the primary display unit and the secondary display unit, the processing unit switches on/off the primary display unit and the secondary display unit.

8. The portable electronic device of claim 7, wherein the processing unit controls one of the primary display unit or the secondary display unit to be in an activated state and the other to be in an inactivated state.

9. The portable electronic device of claim 7, further comprising a sensing unit, wherein the sensing unit is electronically connected to the processing unit, the sensing unit senses which display unit is positioned above the other display unit and controls the display unit positioned above to enter the activated state.

10. The portable electronic device of claim 9, wherein the sensing unit is a gravity sensor.

11. The portable electronic device of claim 8, further comprising a screen sharing unit, wherein when one of the primary display unit and the secondary display unit is in the activated state, and the screen sharing unit is pressed, the processing unit receives a triggering signal from the screen sharing unit and activates the inactivated display unit to synchronously display contents along with the activated display unit in response to the triggering signal.
